(19) United States
(12) Patent Application Publication
(10) Pub. No.: US 2009/0044207 A1
(43) Pub. Date: Feb. 12, 2009

(54) DISC DRIVE APPARATUS

(75) Inventor: Tomoo YAMAGUCHI, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/187,733

(22) Filed: Aug. 7, 2008

(30) Foreign Application Priority Data
Aug. 9, 2007 (JP) 2007-208478

(51) Int. Cl. G11B 17/03; G11B 17/04

(52) U.S. Cl. 720/601; 360/99.02

(57) ABSTRACT

According to one embodiment, a disc drive apparatus includes a main frame having sidewalls and first and second guides disposed on the sidewalls and opposed to each other, a recording medium holder configured to hold a disc recording medium, a medium drive section, and an ascent/descent retaining member which supports the medium drive section and is attached to the main frame for ascent and descent. The retaining member includes a pair of arm portions, a connecting portion which connects respective one-end portions of the arm portions, pivotal portions arranged on the respective other end portions of the arm portions and supported on the sidewalls, and first and second engaging portions disposed on the respective one-end portions of the arm portions for engagement with the first and second guides, respectively. The first guide is formed of a leaf spring and configured to urge the retaining member toward the second guide.

### CROSS-REFERENCE TO RELATED APPLICATIONS

This application is based upon and claims the benefit of priority from Japanese Patent Application No. 2007-208478, filed Aug. 9, 2007, the entire contents of which are incorporated herein by reference.

### BACKGROUND

1. Field

One embodiment of the present invention relates to a disc drive apparatus for processing information on a disc recording medium.

2. Description of the Related Art

In recent years, optical discs have been widespread for use as disc recording media, including the read-only type represented by a DVD-ROM, the one-time recording type represented by a DVD-R, and the rewritable type represented by a DVD-RAM and DVD-RW that can be utilized for externally attached memories for computers, recording and playback video systems, etc.

An optical disc drive apparatus that records or reproduces information to or from an optical disc is provided with a housing having a disc loading slot and a disc tray that loads and unloads the disc into and from the housing. The disc tray is movable between a drawn-out position in which the disc can be loaded and unloaded and a drive position in which the disc that is drawn into the housing can be driven.

The housing contains therein a motor that supports and rotates the loaded optical disc, an optical pickup that reads and writes information from and to the disc, etc. The motor and the pickup are provided on a pickup chassis, which is placed on a chassis mount that is arranged for rotation in the housing.

As the disc tray moves, the pickup chassis, along with the chassis mount, is retracted to a lowered position. When the optical disc is drawn into a predetermined drive position, the pickup chassis and the chassis mount are rocked upward. Thereupon, the motor ascends and clamps the disc, and the optical pickup faces a recording surface of the optical disc.

The optical disc drive apparatus is vibrated as the motor vibrates and the disc rotates eccentrically. Therefore, noise is produced if any mechanical system is loosened. Therefore, as described in Jpn. Pat. Appln. KOKAI Publication No. 2005-190595, for example, there is provided an apparatus in which a pivotal portion of a chassis mount is elastically deformable so that vibration can be absorbed to reduce noise by elastically engaging the pivotal portion with a support portion of a housing.

For the optical disc drive apparatus described above, although looseness of the pivotal portion of the chassis mount can be suppressed, no measure is taken to counter vibration at a swing portion of the chassis mount that is distant from the pivotal portion. A cushioning material or an urging member may be additionally used to reduce looseness of the component members. In this case, however, the manufacturing cost is increased inevitably. In some cases, moreover, physical looseness may be generated by contraction or expansion of the components that is caused by a temperature change. Alternatively, the components may engage with one another and cause an overload, which hinders some operations. In many cases, the housing and the chassis mount are formed of materials with different coefficients of linear expansion. In a low-temperature environment, therefore, the housing and the chassis mount engage with each other owing to a difference in the amount of linear thermal expansion, so that the chassis mount may possibly be prevented from moving smoothly.

If a plurality of molds are used to form one and the same component, moreover, the dimensions of the component delicately vary according to the molds used. Therefore, looseness may be caused depending on the combination of components or operations may be hindered by an overload.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the internal structure of an optical disc drive apparatus according to an embodiment of the invention with its top cover off;

FIG. 2 is an exemplary perspective view showing the internal structure of the optical disc drive apparatus with its disc tray omitted;

FIG. 3 is an exemplary perspective view showing the underside of the optical disc drive apparatus;

FIG. 4 is an exemplary perspective view showing a chassis mount of the optical disc drive apparatus;

FIG. 5 is an exemplary perspective view showing the chassis mount, a cam slider, and a moving mechanism of the optical disc drive apparatus;

FIG. 6 is an exemplary perspective view showing the chassis mount, the cam slider, and the moving mechanism from a different direction;

FIG. 7 is an exemplary perspective view showing a chassis of a disc drive section;

FIG. 8 is an exemplary perspective view showing the disc drive section, the chassis mount, and a circuit board;

FIG. 9 is an exemplary cross-sectional view of the optical disc drive apparatus with the disc drive section in a raised position;

FIG. 10 is an exemplary longitudinal sectional view of the optical disc drive apparatus with the disc drive section in a lowered position;

FIG. 11 is an exemplary enlarged perspective view showing a first guide portion and the chassis mount of the optical disc drive apparatus;

FIG. 12 is an exemplary enlarged perspective view showing a second guide portion and the chassis mount of the optical disc drive apparatus;

FIG. 13A is an exemplary enlarged front view showing the first guide portion;

FIG. 13B is an exemplary sectional view taken along line XIIIB-XIIIB of FIG. 13A;

FIG. 14A is an exemplary enlarged front view showing the second guide portion;

FIG. 14B is an exemplary sectional view taken along line XIVB-XIVB of FIG. 14A;

FIG. 15 is an exemplary sectional view taken along line XV-XV of FIG. 2, showing the chassis mount in a raised position and first and second guides;

FIG. 16 is an exemplary sectional view taken along line XV-XV of FIG. 2, showing the chassis mount in a lowered position and the first and second guides;

FIG. 17 is an exemplary sectional view showing the chassis mount in the lowered position and a third guide rib;

FIG. 18 is an exemplary plan view showing the bottom surface of the optical disc drive apparatus;

FIG. 19 is an exemplary side view showing the chassis mount in the raised position, the disc drive section, and a second flexible cable; and

FIG. 20 is an exemplary side view showing the chassis mount in the lowered position, the disc drive section, and the second flexible cable.

### DETAILED DESCRIPTION

Various embodiments according to the invention will be described hereinafter with reference to the accompanying drawings. In general, according to one embodiment of the invention, there is provided a disc drive apparatus comprising: a main frame including sidewalls opposed to each other and a first guide and a second guide disposed individually on the sidewalls and opposed to each other; a recording medium holder which is configured to hold a disc recording medium and is arranged on the main frame for movement between an unloaded position in which the holder projects out of the main frame and an operating position in which the recording medium is configured to be driven in a predetermined position in the main frame; a medium drive section including a motor which is configured to support and rotate the recording medium and a head portion configured to process information on the recording medium and arranged for ascent and descent between a retracted position in which the recording medium is allowed to be loaded and unloaded and a drive position in which the recording medium is driven; and an ascent/descent retaining member which supports the medium drive section and is attached to the main frame for ascent and descent between a raised position corresponding to the drive position and a lowered position corresponding to the retracted position, the ascent/descent retaining member including a pair of arm portions extending opposite the sidewalls, individually, a connecting portion which connects respective one-end portions of the arm portions and extends in a direction across the sidewalls, pivotal portions arranged on the respective other end portions of the arm portions and supported on the sidewalls, individually, and a first engaging portion and a second engaging portion disposed individually on the respective one-end portions of the arm portions for engagement with the first and second guides, respectively, the first guide being formed of a leaf spring and configured to urge the ascent/descent retaining member toward the second guide.

A disc drive apparatus according to an embodiment of this invention will now be described in detail with reference to the accompanying drawings.

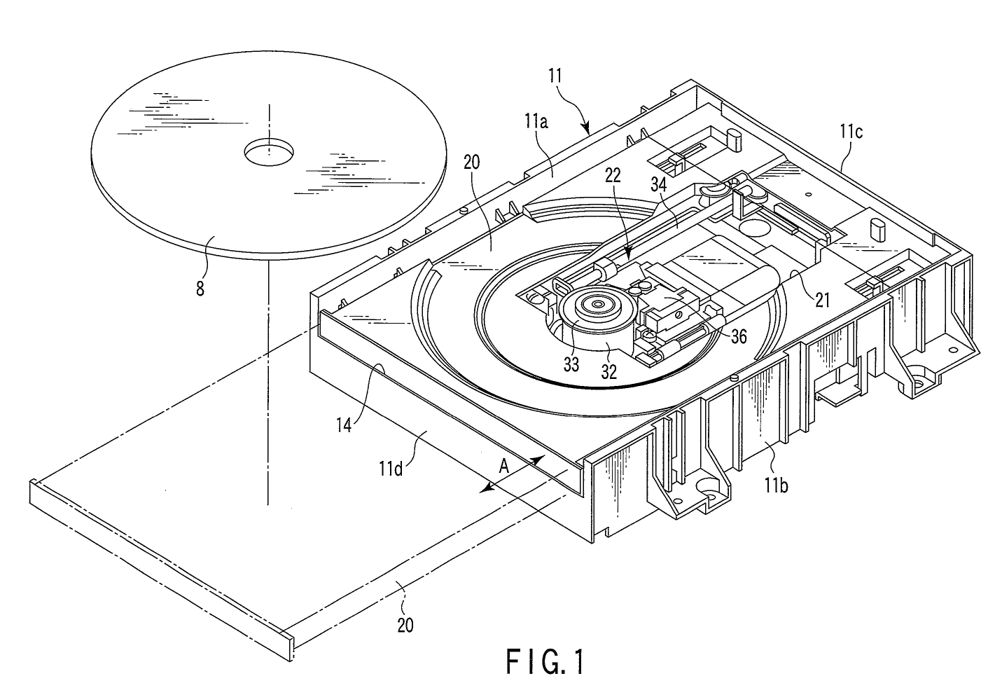

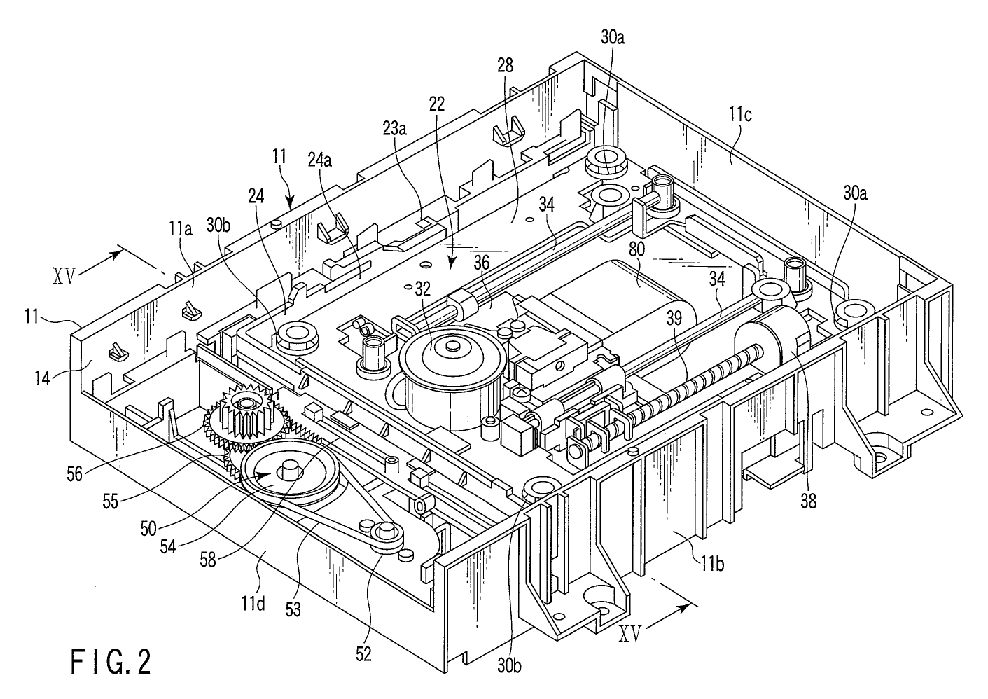

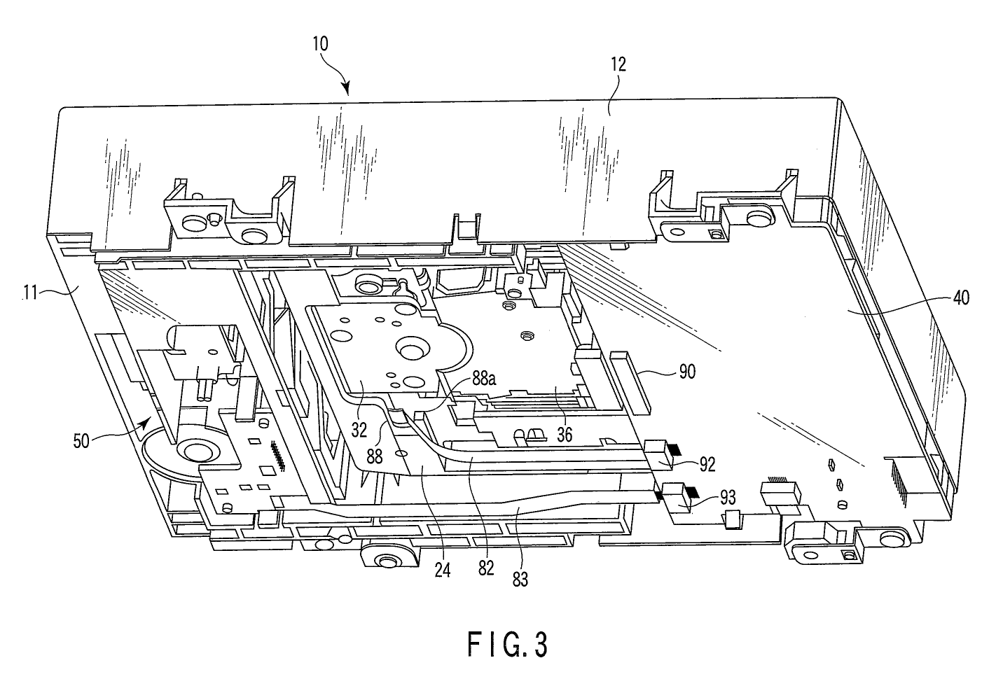

FIG. 1 shows the internal structure of the optical disc drive apparatus according to the present embodiment with its top cover off. FIG. 2 shows the internal structure of the optical disc drive apparatus with its disc tray (mentioned later) omitted. FIG. 3 shows the reverse side of the optical disc drive apparatus with its top cover on.

As shown in FIGS. 1 to 3, the optical disc drive apparatus is provided with a housing 10 in the form of a rectangular box. The housing includes a main frame 11 and a top cover 12 that covers the top surface and two opposite side surfaces of the main frame. The main frame 11 is formed of a synthetic resin, such as ABS, and provided integrally with a pair of sidewalls 11a and 11b, which are spaced and opposed parallel to each other, a rear wall 11c, and a front wall 11d. A disc loading slot 14 having the shape of a rectangular opening is formed in one longitudinal end portion of the main frame 11, that is, in the front wall 11d.

A disc tray 20, a liftable disc drive section 22, and a moving mechanism 50 are arranged in the main frame 11. The disc tray 20 holds and transports an optical disc 8 for use as a recording medium. The disc drive section 22 serves to support and rotate the optical disc. The moving mechanism 50 can move the disc tray and the disc drive section. A circuit board 40 that constitutes a control section is mounted on the bottom surface of the main frame 11.

The disc tray 20, which functions as a recording medium holder, is a substantially rectangular plate. A window 21 that allows the disc drive section 22 to access the optical disc 8 is formed in a part of the disc tray. The disc tray 20 is located between the sidewalls 11a and 11b and supported for movement parallel to the sidewalls, that is, along the longitudinal length of the main frame 11. More specifically, the disc tray 20 is supported for linear movement between an operating position indicated by solid line in FIG. 1, in which it is withdrawn in a predetermined position in the main frame 11, and an unloaded position indicated by two-dot and dashed line in FIG. 1, in which the tray 20 projects outward from the housing 10 through the disc loading slot 14. In the operating position, the optical disc 8 held on the disc tray 20 can be driven by the disc drive section 22. In the unloaded position, the optical disc 8 can be loaded onto and unloaded from the tray 20.

As shown in FIGS. 2, 4, 5 and 6, the main frame 11 is provided with a chassis mount 24 that supports the disc drive section 22 for up-and-down motion. The chassis mount 24 is substantially U-shaped and is rockably attached to the main frame 11. The chassis mount 24, which functions as an ascent/descent retaining member, includes a pair of arm portions 24a and 24b and a connecting portion 24c. The arm portions 24a and 24b are spaced and opposed parallel to each other. The connecting portion 24c extends at right angles to the arm portions and connects the respective distal ends of the arm portions. The chassis mount 24 is molded from, for example, a resin that is harder than the material of the main frame 11.

Pivots 23a and 23b that serve as axes of rotation are formed on the rear end parts of the arm portions 24a and 24b, respectively, and project outward from the arm portions. First and second engaging lugs 27a and 27b are formed on the distal end portions of the arm portions 24a and 24b, respectively, and project outward from the arm portions. A third engaging lug 27c protrudes from that part of the arm portion 24a which is situated behind the first engaging lug 27a, that is, in a position nearer to the pivot 23a. The first, second, and third engaging lugs 27a, 27b and 27c function as first, second, and third engaging portions, respectively.

A pair of support pins 25 that support the disc drive section 22 are provided individually inside two corner portions of the chassis mount 24. The chassis mount 24 includes a notch 88 and a hook 88a, which are disposed near one of the support pins 25, and a pair of engaging pins 26 that engage with a slide cam of the moving mechanism 50 (mentioned later). The engaging pins 26 project forward from the connecting portion 24c.

As shown in FIG. 2, the chassis mount 24 is attached to the main frame 11 in such a manner that the pivots 23a and 23b are rockably supported on the sidewalls 11a and 11b, respectively, of the main frame. The pair of arm portions 24a and 24b extend parallel to the sidewalls 11a and 11b, respectively. The connecting portion 24c is situated nearer to the disc loading slot 14 than the pivots 23a and 23b are and extend at right angles to these sidewalls. The chassis mount 24 is supported so as to be rockable around the pivots 23a and 23b between raised and lowered positions.

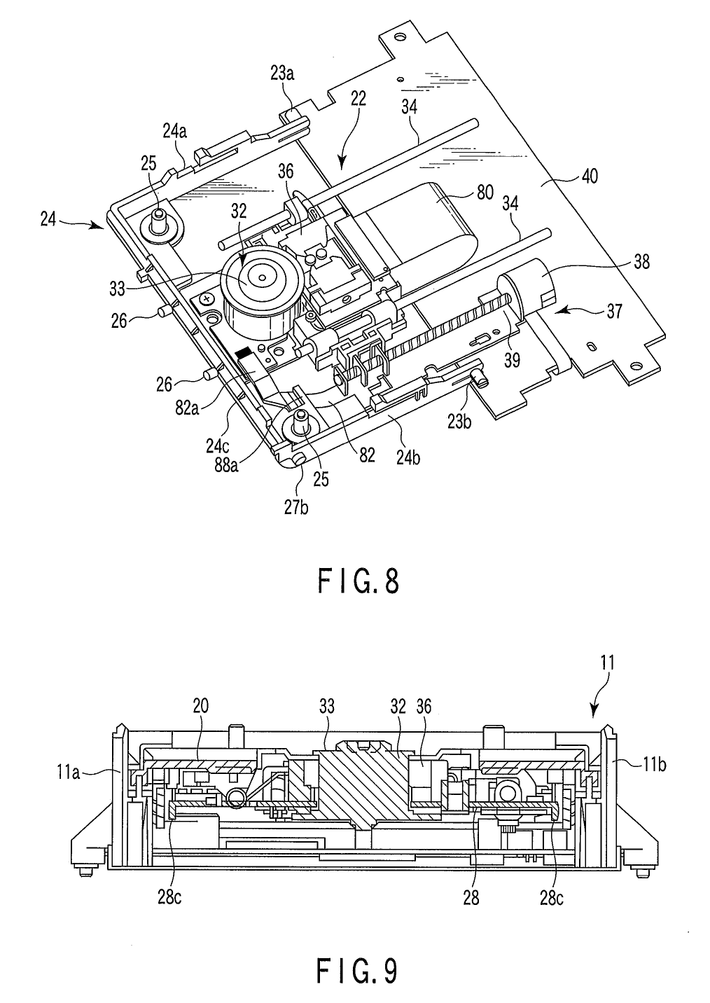

FIG. 7 shows a chassis 28 of the disc drive section 22, and FIG. 8 shows the chassis mount 24 and other component members of the disc drive section than the chassis.

As shown in FIGS. 2, 7 and 8, the disc drive section 22 includes the chassis 28 in the form of a rectangular metal frame. A spindle motor 32 for use as a drive source is mounted on a longitudinal front end portion of the chassis 28. A turntable 33 that supports and rotates the optical disc 8 at a predetermined speed is fixed on a rotating shaft of the spindle motor. The chassis 28 is fitted with a pair of guide rails 34 that extend parallel to each other. The rails 34 extend substantially parallel to the sidewalls 11a and 11b of the main frame 11.

The disc drive section 22 is provided with an optical pickup 36 and a pickup drive mechanism 37. The optical pickup 36 writes and reads information to and from the optical disc 8. The pickup drive mechanism 37 serves to move the optical pickup. The optical pickup 36 is supported by the guide rails 34 for movement along the rails. The pickup drive mechanism 37 includes a stepping motor 38 mounted on the chassis 28 and a lead screw 39 connected to a rotating shaft of the stepping motor. The lead screw 39 extends parallel to the guide rails 34 and is in engagement with the optical pickup 36.

The optical pickup 36, which functions as a head portion, is opposed to a surface of the optical disc 8 supported on the turntable 33 and moved radially of the disc along the guide rails 34 by the pickup drive mechanism 37 as it reads and writes information from and to the disc.

As shown in FIGS. 2 and 7, four through-holes 29 for engagement with dampers are formed individually at four corner portions of the chassis 28. The two corner portions of the chassis 28 on one longitudinal end side (rear end side) thereof are elastically supported on the main frame 11 by a pair of first dampers 30a, while the other longitudinal end side (front end side) of the chassis is supported on the support pins 25 of the chassis mount 24 by a pair of second dampers 30b. Thus, the chassis 28 is elastically supported by the four dampers 30a and 30b.

The disc drive section 22 is supported for rocking or up-and-down motion in conjunction with the chassis mount 24, around the pair of first dampers 30a and between a raised position (drive position) shown in FIG. 9 and a lowered position (retracted position) shown in FIG. 10. In the drive position, the chassis 28 is situated substantially parallel to the disc tray 20. In the retracted position, the end portion of the chassis 28 on the side of the second dampers 30b is spaced downward from the tray 20.

For higher rigidity, as shown in FIGS. 7, 9 and 10, front and rear end edges 28a and 28b of the chassis 28 are bent upward or toward the optical disc 8 at substantially right angles, and a pair of opposite side edges 28c that extend parallel to the sidewalls 11a and lib are bent downward at substantially right angles. If the front end edge 28a of the chassis 28 is bent downward with the chassis mount 24 and the disc drive section 22 in the lowered position, as shown in FIG. 10, the chassis mount and a disc motor base must inevitably be located in lower positions. Therefore, it is difficult to reduce the thickness of the disc drive apparatus. Thus, the disc drive apparatus can be thinned by bending the front end edge 28a of the chassis 28 upward, as in the present embodiment.

If the opposite side edges 28c of the chassis 28 are bent upward with the chassis mount 24 and the disc drive section 22 in the raised position, as shown in FIG. 9, a gap between the reverse surface of the disc tray 20 and the drive section cannot be maintained, so that it is hard to secure a sufficient bending height. Accordingly, a satisfactory structure cannot be achieved for the purpose of enhancing the rigidity. In the present embodiment, therefore, the opposite side edges 28c of the chassis 28 are bent downward. Thus, the rigidity of the chassis 28 can be fully enhanced.

As shown in FIGS. 2, 5 and 6, the moving mechanism 50 for moving the disc tray 20 and the disc drive section 22 is arranged on the loading-slot side of the main frame 11 and situated below the disc tray 20. The moving mechanism 50 is provided with a loading motor 51, a pulley 52 press-fitted on a rotating shaft of the loading motor, a pulley gear 54, a drive belt 53 passed around and between the pulley 52 and the pulley gear 54, a relay gear 55, a tray gear 56, and a cam slider 58. The rotating shaft of the loading motor 51 and respective rotating shafts of the pulley 52, pulley gear 54, relay gear 55, and tray gear 56 extend at right angles to the surface of the disc tray 20.

The pulley gear 54 is in mesh with the relay gear 55, which is in mesh with the tray gear 56. The tray gear 56 is in mesh with a rack (not shown) formed on the reverse surface of the disc tray 20. The rack extends along the moving direction of the tray 20.

The cam slider 58, which functions as a sliding member, integrally includes an elongated slide rod 58a that extends in a direction B perpendicular to a moving direction A of the disc tray 20 and a cam plate 58b that extends vertically downward from the slide rod and faces the chassis mount 24. The cam slider 58 is supported on the main frame 11 for movement in the direction B perpendicular to the moving direction A of the disc tray 20.

A rack 60 that can mesh with the tray gear 56 is formed on one end portion of the slide rod 58a. The cam slider 58 is driven by the tray gear 56 and moved in the moving direction B as the disc tray 20 moves. The cam plate 58b is formed with a pair of cam grooves 64 that individually extend aslant. The engaging pins 26 that protrude from the chassis mount 24 engage with the cam grooves 64, individually.

When the loading motor 51 of the moving mechanism 50 is driven, power is transmitted from the pulley 52 to the pulley gear 54, relay gear 55, and tray gear 56 via the drive belt 53, whereby the cam slider 58 is moved in the moving direction B. As the slider 58 moves, the engaging pins 26 of the chassis mount 24 move along the cam grooves 64. In association with the movement of the cam slider 58, moreover, the chassis mount 24 rocks around the pivots 23a and 23b and ascends or descends. Thereupon, the disc drive section 22 rocks around the first dampers 30a and ascends or descends together with the chassis mount 24.

The disc tray 20 is driven to move in the moving direction A by the tray gear 56. While the disc tray 20 moves, the disc drive section 22 is moved to the lowered position (retracted position) lest it hinder the movement of the disc tray.

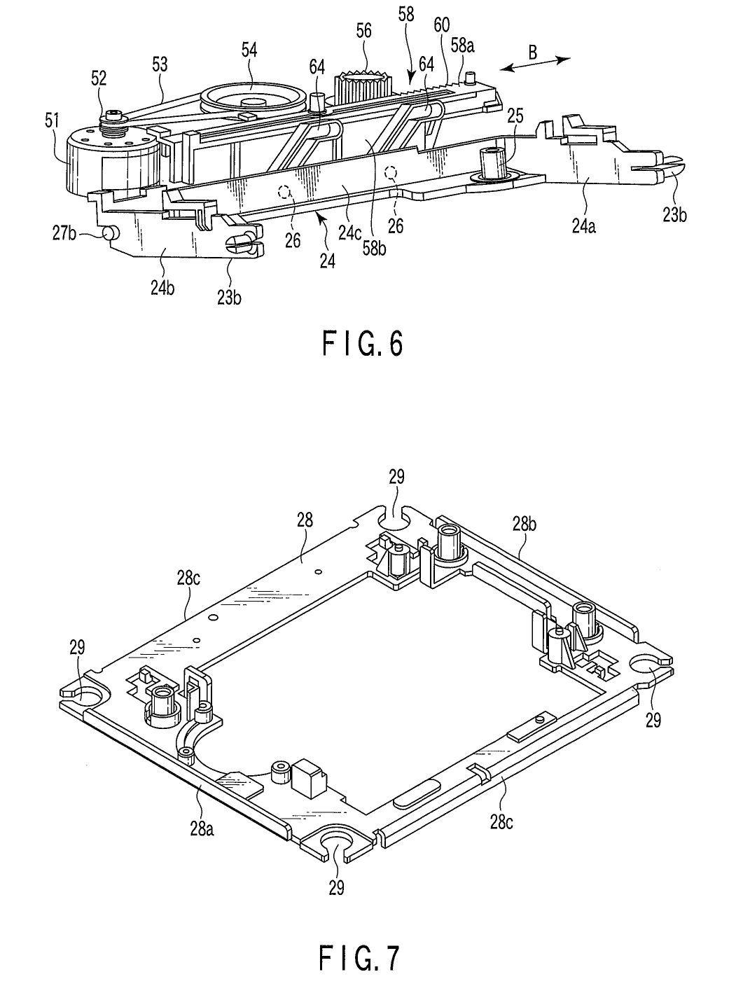

In loading or unloading the optical disc 8 into or from the optical disc drive apparatus, the loading motor 51 is driven by depressing an eject button (not shown) on the front surface of the main frame 11 or in response to an external instruction for optical disc unloading. Thereupon, the cam slider 58 is moved in the direction B from a first position shown in FIGS. 2 and 5 toward a second position shown in FIG. 6. In association with the movement of the cam slider 58, the disc drive section 22 is lowered from the drive position to the retracted position.

After the disc drive section 22 is moved to the retracted position, the disc tray 20 is moved from the operating position indicated by solid line in FIG. 1 to the unloaded position indicated by two-dot and dashed line in FIG. 1. In this state, the optical disc 8 can be loaded onto or unloaded from the tray 20.

If an external instruction for optical disc loading is input after the optical disc 8 is placed and loaded on the disc tray 20, the loading motor 51 is reversely driven so that the tray 20 is moved from the unloaded position to the operating position. Thereupon, the disc 8, along with the tray 20, is dawn into the main frame 11 and held in the predetermined position.

When the disc tray 20 is in the operating position, the cam slider 58 is moved from the second position to the first position. In association with the movement of the slider 58, the disc drive section 22 ascends from the retracted position to the drive position. Thereupon, the optical disc 8 having been placed on the disc tray 20 is sandwiched and held for rotation between the turntable 33 of the disc drive section 22 and a disc clamping member (not shown) on the inner surface of the top cover 12. Further, the optical pickup 36 is situated opposite a recording surface of the optical disc 8. In this state, the turntable 33 and the disc 8 are rotated at the predetermined speed by the spindle motor 32, and information is written to or read from the disc 8 by the pickup 36.

On the other hand, the disc drive apparatus is provided with a guide mechanism that guides the chassis mount 24 for ascent/descent operation, holds it in a predetermined position, and prevents its vibration. As shown in FIGS. 2, 11 and 12, a first guide 70a is formed on the sidewall 11a of the main frame 11, and a second guide 70b on the sidewall 11b. The first and second guides 70a and 70b are opposed to each other along the width of the frame 11 and situated individually opposite two opposite end portions of the connecting portion 24c that constitutes the chassis mount 24.

As shown in FIGS. 11, 13A, 13B and 15, the first guide 70a is constructed by forming a U-shaped slit 71 in the sidewall 11a and constitutes a leaf spring or resin spring that is deformable along the width of the main frame 11. A first guide rib 72a that extends vertically or along the ascent and descent of the chassis mount 24 protrudes from the first guide 70a. The first guide rib 72a is formed for engagement with the first engaging lug 27a of the chassis mount 24. Specifically, the first guide rib 72a is arranged along the path of movement of the first engaging lug 27a and located, in particular, in a region where it engages with the lug 27a as the chassis mount 24 moving from the lowered position to the raised position moves from a position just short of the raised position to the raised position. The first guide rib 72a is situated overlapping the first engaging lug 27a along the width of the main frame 11. By engaging with the first engaging lug 27a, the first guide rib 72a regulates the movement of the chassis mount 24 along the width of the frame 11. The lower end portion of the first guide rib 72a is formed with an inclination such that the first engaging lug 27a can smoothly engage with the rib 72a as the chassis mount 24 ascends.

Further, a substantially U-shaped positioning projection 74a is formed on the upper end portion of the first guide 70a so as to surround the first guide rib 72a. The positioning projection 74a faces the first engaging lug 27a, prevents an excessive ascent of the chassis mount 24, and prevents the chassis mount from being displaced along its longitudinal length, that is, along the movement of the disc tray 20 when the chassis mount is moved to the raised position (drive position).

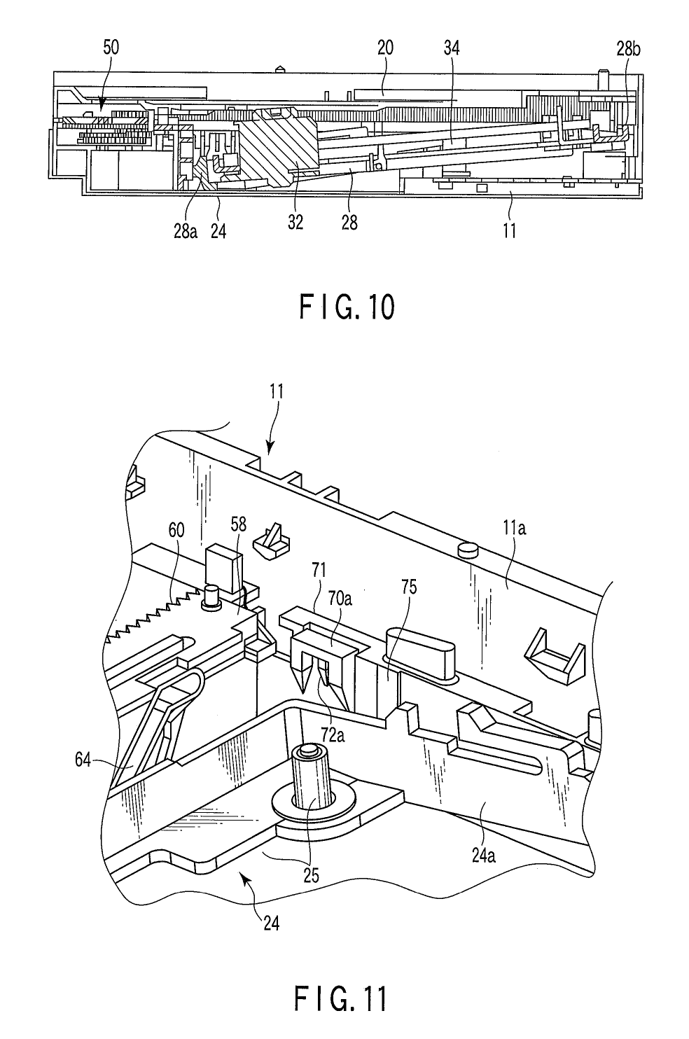

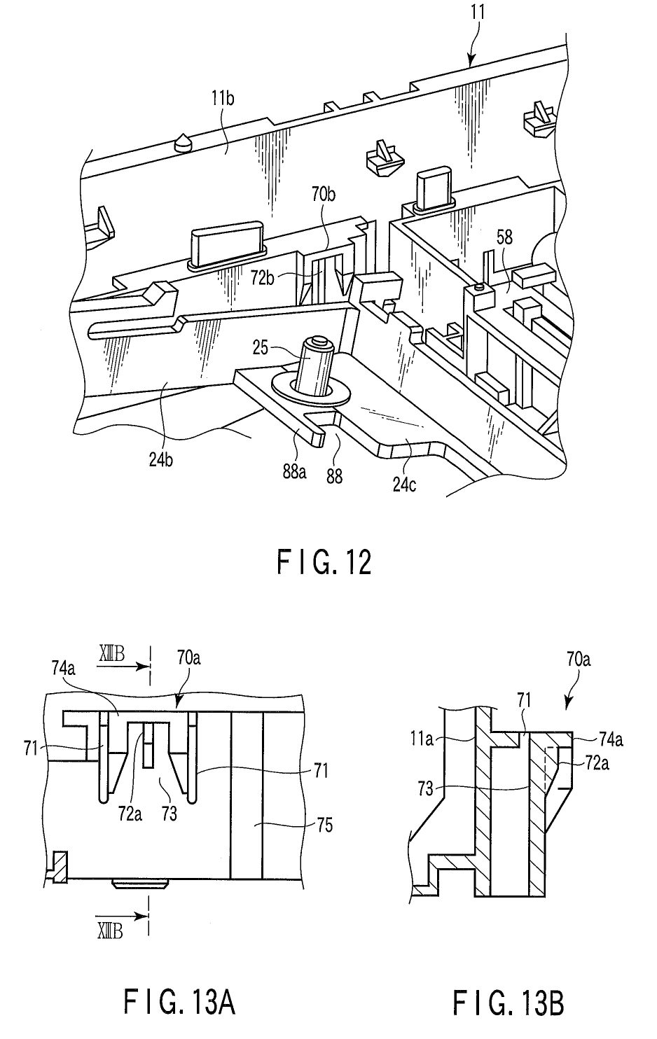

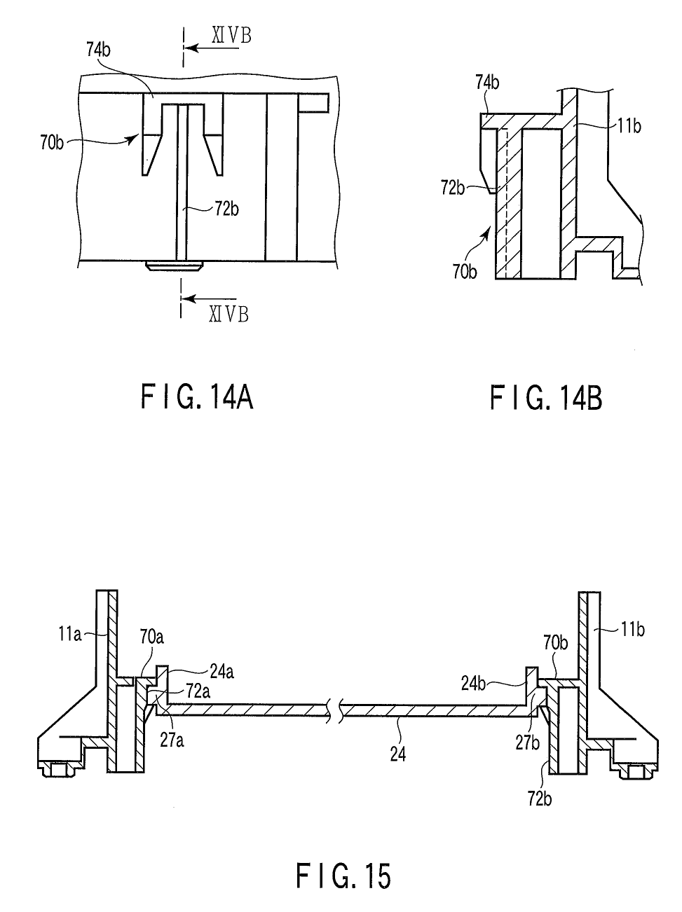

As shown in FIGS. 12, 14A, 14B and 15, the second guide 70b protrudes from the inner surface of the sidewall 11b and includes a second guide rib 72b that extends vertically or along the ascent and descent of the chassis mount 24. The second guide rib 72b is formed for engagement with the second engaging lug 27b of the chassis mount 24. Specifically, the second guide rib 72b is arranged along the overall length of the movement path of the second engaging lug 27b and located in a region where it engages with the lug 27b as the chassis mount 24 moves from the lowered position to the raised position. The second guide rib 72b is situated overlapping the second engaging lug 27b along the width of the main frame 11. By engaging with the second engaging lug 27b, the second guide rib 72b regulates the movement of the chassis mount 24 along the width of the frame 11.

A substantially U-shaped positioning projection 74b is formed on the upper end portion of the second guide 70b so as to surround the upper end portion of the second guide rib 72b. The positioning projection 74b faces the second engaging lug 27b, prevents an excessive ascent of the chassis mount 24, and prevents the chassis mount from being displaced along its longitudinal length, that is, along the movement of the disc tray 20 when the chassis mount is moved to the raised position (drive position).

As described above, the second guide rib 72b of the second guide 70b, which is arranged on the side where the cam slider 58 moves in the direction to raise the chassis mount 24, that is, on the first position side of the cam slider, is formed long enough to cover the overall length of the movement path of the second engaging lug 27b. In contrast with this, the first guide rib 72a of the first guide 70a, which is arranged on the side where the cam slider 58 moves in the direction to lower the chassis mount 24, that is, on the second position side of the cam slider, is short and has a slope at its lower end portion and a guide portion that serves as a resin spring.

As shown in FIGS. 11, 13A, 13B and 17, a third guide rib 75 is formed on the sidewall 11a that is provided with the first guide 70a. The third guide rib 75 protrudes from the inner surface of the sidewall 11a and extends along the height of the sidewall, that is, along the ascent and descent of the chassis mount 24. The guide rib 75 is formed for engagement with the third engaging lug 27c of the chassis mount 24. Specifically, the third guide rib 75 is provided along the overall length of the movement path of the third engaging lug 27c and located in a region where it engages with the second engaging lug 27b as the chassis mount 24 moves from the lowered position to the raised position. The third guide rib 75 is situated overlapping the third engaging lug 27c along the width of the main frame 11. By engaging with the third engaging lug 27c, the third guide rib 75 regulates the movement of the chassis mount 24 along the width of the frame 11.

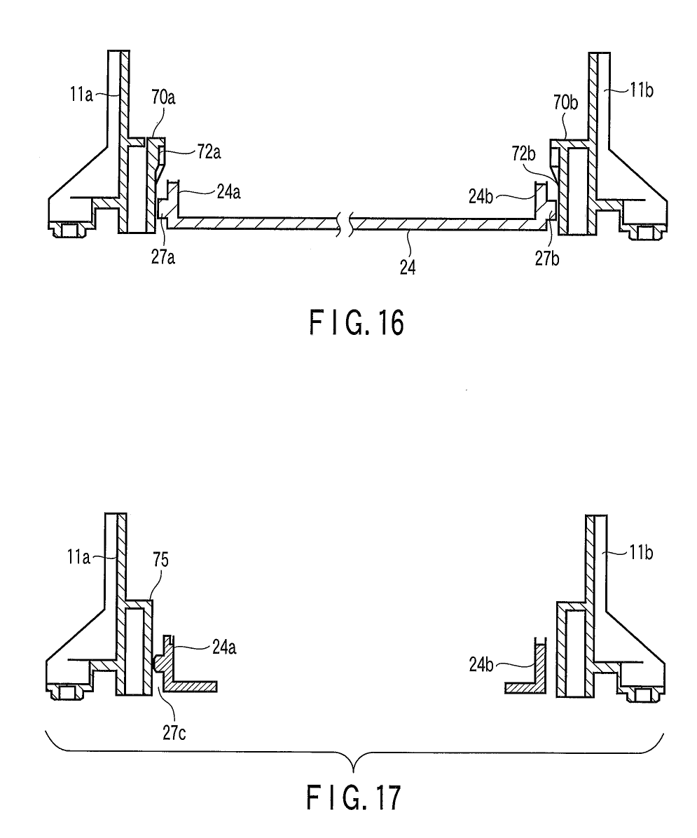

As the cam slider 58 moves from the second position to the first position to clamp the loaded optical disc 8, the chassis mount 24 starts to ascend from the lowered position shown in FIG. 16. When this is done, the chassis mount 24 is pressed by the cam slider 58 so that it undergoes a deflection toward the first position, that is, to the right of the second guide 70b. Since the second engaging lug 27b of the chassis mount 24 and the second guide rib 72b are in contact with each other, the deflection of the chassis mount can be minimized. In addition, a gap is defined between the first engaging lug 27a of the chassis mount 24 and the first guide rib 72a. In the interval from the lowered position to the position just short of the raised position, therefore, a sliding load on the chassis mount 24 can be minimized to ensure a smooth movement of the chassis mount.

As shown in FIG. 15, thereafter, the first engaging lug 27a engages with the first guide rib 72a immediately before a disc clamping operation, that is, just before the chassis mount 24 reaches the raised position. Since the first guide 70a is formed like a resin spring, it is deformed outward by the first engaging lug 27a when the lug 27a engages with the first guide rib 72a. Thereupon, an urging force is generated by the resin spring. Accordingly, the chassis mount 24 is elastically urged toward the second guide 70b and held without looseness by the first guide 70a. Thus, vibration of the chassis mount 24 and generation of noise, which are attributable to vibrations of the motors, eccentric rotation of the optical disc 8, etc., can be suppressed.

The urging force of the resin spring of the first guide 70a acts appropriately if the components contract or expand within a supposable range of temperature change or the deflection changes within normal ranges of dimensional dispersion of the components. Further, differences in contraction and expansion of the components attributable to differences between their coefficients of linear expansion can be absorbed by elastic deformation of the first guide 70a, so that the sliding load on the chassis mount can be minimized.

As the cam slider 58 moves from the first position to the second position to unclamp the loaded optical disc 8, the chassis mount 24 starts to descend from the raised position shown in FIG. 15. When this is done, the first engaging lug 27a and the first guide rib 72a are disengaged from each other to secure a gap. Accordingly, the sliding load on the chassis mount 24 in the interval of movement to the lowered position can be minimized.

While the chassis mount 24 moves from the raised position to the lowered position, it is pressed toward the sidewall 11a by the cam slider 58 so that it undergoes a deflection opposite to that caused during the ascent. During the descent, as shown in FIG. 17, however, the third engaging lug 27c on the chassis mount 24 contacts the third guide rib 75 on the inner surface of the sidewall 11a. Thereupon, the deflection of the chassis mount 24 is minimized. Thus, fluctuations of the load on the chassis mount 24 can be minimized to ensure a smooth operation.

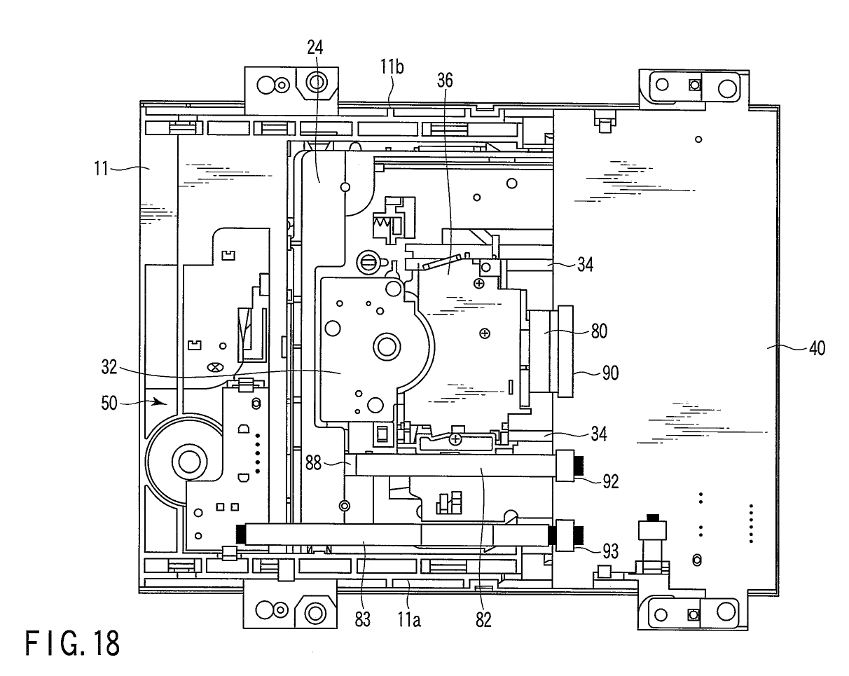

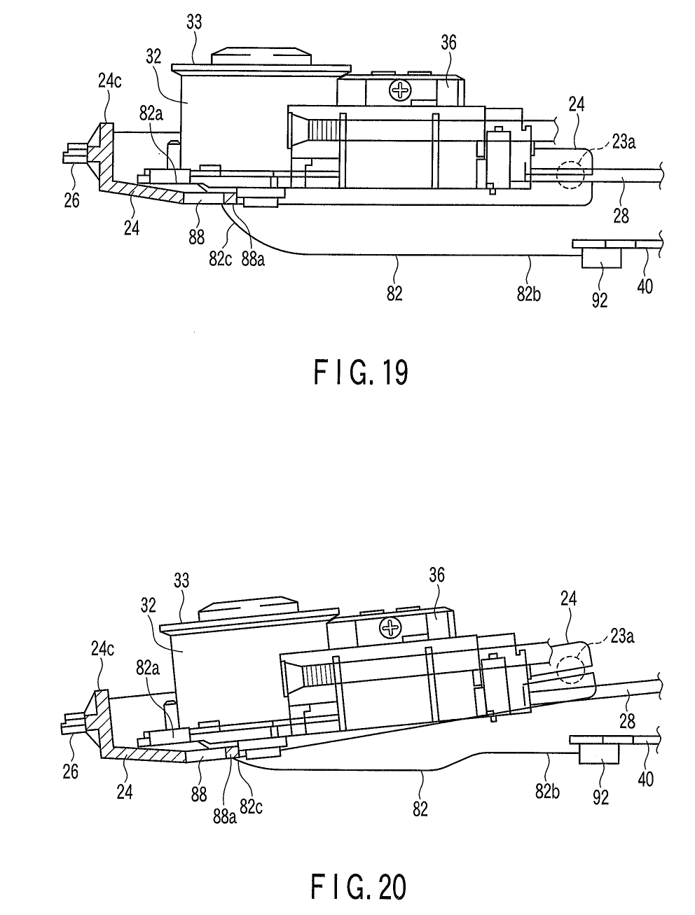

In the disc drive section 22, as shown in FIGS. 3, 8, 18, 19 and 20, the optical pickup 36 is electrically connected to the circuit board 40 by a first flexible cable (FPC) 80. One end of the first FPC 80 is connected to the main body of the optical pickup 36, and the other end to a connector 90 that is mounted on the circuit board 40.

The spindle motor 32 of the disc drive section 22 is electrically connected to the circuit board 40 by a second FPC 82. One end 82a of the second FPC 82 is connected to the spindle motor 32, and the other end 82b to a connector 92 that is mounted on the circuit board 40. Further, the loading motor 51 of the moving mechanism 50 is electrically connected to the circuit board 40 by a third FPC 83. One end of the third FPC 83 is connected to the loading motor 51, and the other end to a connector 93 that is mounted on the circuit board 40.

The second and third FPCs 82 and 83 must be provided lest they contact the movable optical pickup 36. Therefore, the FPCs 82 and 83 must be located lest they overlap the pickup 36 on a projection plane along an axis of disc rotation. Alternatively, if the FPCs 82 and 83 are located overlapping the pickup 36 on the projection plane along the rotation axis, a large enough gap must be secured between the optical pickup and the FPCs.

According to the present embodiment, the third FPC 83 is located lest it overlap the optical pickup 36 on the projection plane along the disc rotation axis. On the other hand, the second FPC 82 is located overlapping the pickup 36 on the same projection plane. Accordingly, the one end 82a of the second FPC 82 that projects from the spindle motor 32 is prevented from moving downward by the chassis mount 24. A portion 82c of the second FPC 82 that is situated nearer to the circuit board 40 than the one end 82a is prevented from moving upward by the chassis mount 24. The distance between the portion 82c and the optical disc 8 is greater than that between the one end 82a and the optical disc. Thus, that part of the second FPC 82 which is situated nearer to the circuit board 40 than the chassis mount 24 is controlled to move away from the optical disc 8, whereby the optical pickup 36 and the second FPC 82 are securely prevented from contacting each other.

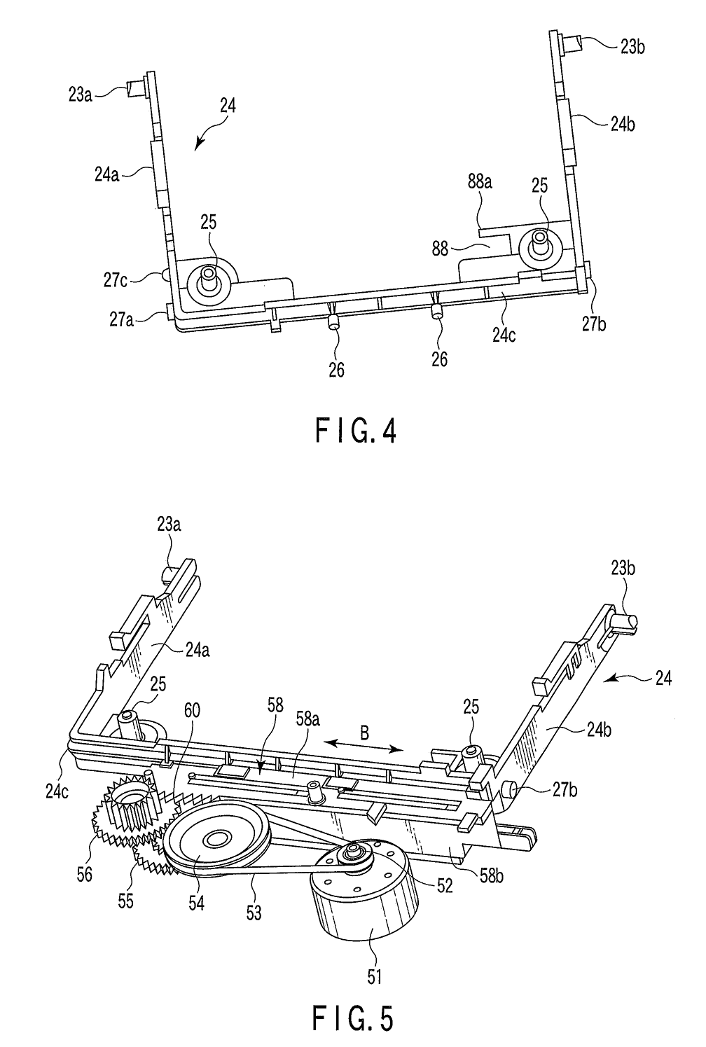

More specifically, as shown in FIGS. 4 and 12, the connecting portion 24c of the chassis mount 24 is formed with a notch 88 through which the second FPC 82 is passed and a hook 88a that adjoins the notch. As shown in FIGS. 3, 8, 18, 19 and 20, the second FPC 82 extends along the upper surface of the connecting portion 24c of the chassis mount 24 from the spindle motor 32 and is then bent toward the circuit board 40. The portion 82c that is continuous with the bent portion of the second FPC 82 extends from the upper surface side of the chassis mount 24 toward the lower surface through the notch 88 in the chassis mount. Further, the second FPC 82 extends to the circuit board 40 through the space under the hook 88a. With this arrangement, the one end 82a of the second FPC 82 is prevented from moving downward by the chassis mount 24, and the portion 82c of the second FPC is prevented from moving upward or toward the optical pickup 36 by the hook 88a of the chassis mount that functions as a position regulating portion. Thus, that part of the second FPC 82 which extends from the chassis mount 24 to the circuit board 40 is urged downward or away from the optical pickup 36, so that a gap is secured between the urged part and the pickup.

Even in the case where the optical pickup 36 and the second FPC 82 are thus arranged overlapping each other on the projection plane along the disc rotation axis, they can be securely prevented from contacting each other by means of a simple structure. Consequently, there can be realized a low-priced disc drive apparatus that can be reduced in thickness.

According to the optical disc drive apparatus constructed in this manner, a pair of guide ribs of different shapes for guiding and holding the chassis mount are provided on the main frame side, and one of the guide ribs is formed as a resin spring. The chassis mount is provided with an engaging lug for regulating the crosswise movement, and another engaging lug is provided for preventing deflection. Therefore, the chassis mount and the disc drive section can be held without looseness by the use of a simple, low-priced structure, without regard to fine dimensional differences attributable to differences in mold design and contraction or expansion of the components that is caused by a temperature change. Thus, vibration of the chassis mount and generation of noise, which are attributable to eccentric rotation of the disc and the like, can be suppressed. Further, fluctuations in load that are attributable to the sliding load and a deflection of the ascending or descending chassis mount can be reduced. Thus, there may be obtained a disc drive apparatus free from looseness and capable of suppressing an overload, thereby ensuring a smooth movement.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, the materials, shapes, etc., of the components are not limited to the embodiments described herein, but can be changed as required.

What is claimed is:

1. A disc drive apparatus comprising:
a main frame including sidewalls opposed to each other and a first guide and a second guide disposed individually on the sidewalls and opposed to each other;
a recording medium holder which is configured to hold a disc recording medium and is arranged on the main frame for movement between an unloaded position in which the holder projects out of the main frame and an operating position in which the recording medium is configured to be driven in a predetermined position in the main frame;
a medium drive section including a motor which is configured to support and rotate the recording medium and a head portion configured to process information on the recording medium and arranged for ascent and descent between a retracted position in which the recording medium is allowed to be loaded and unloaded and a drive position in which the recording medium is driven; and
an ascent/descent retaining member which supports the medium drive section and is attached to the main frame for ascent and descent between a raised position corresponding to the drive position and a lowered position corresponding to the retracted position,
the ascent/descent retaining member including a pair of arm portions extending opposite the sidewalls, individually, a connecting portion which connects respective one-end portions of the arm portions and extends in a direction across the sidewalls, pivotal portions arranged on the respective other end portions of the arm portions and supported on the sidewalls, individually, and a first engaging portion and a second engaging portion disposed individually on the respective one-end portions of the arm portions for engagement with the first and second guides, respectively,
the first guide being formed of a leaf spring and configured to urge the ascent/descent retaining member toward the second guide.

2. The disc drive apparatus according to claim 1, wherein the main frame is formed of a resin, and the first guide is molded integrally with the sidewalls from a resin.

3. The disc drive apparatus according to claim 1, which further comprises a moving mechanism which moves the ascent/descent retaining member to the retracted position while the recording medium holder is moving and moves the ascent/descent retaining member and the medium drive section to the drive position when the recording medium holder is moved to the operating position,
the moving mechanism including a sliding member which engages with the ascent/descent retaining member, is arranged between the pair of sidewalls so as to be movable in a direction across the sidewalls, and moves to raise and lower the ascent/descent retaining member; and a drive source configured to move the sliding member,
wherein the first guide includes a first guide rib which protrudes from the corresponding sidewall, extends along the direction of ascent and descent of the ascent/descent retaining member, and is configured to engage with the first engaging portion,
the second guide includes a second guide rib which protrudes from the corresponding sidewall, extends along the direction of ascent and descent of the ascent/descent retaining member, and is configured to engage with the second engaging portion, and
the second guide rib of the second guide which is situated on the side where the sliding member moves in a direction to raise the ascent/descent retaining member is longer than the first guide rib of the first guide.

4. The disc drive apparatus according to claim 3, wherein the second guide rib extends along a movement path of the second engaging portion so as to engage with the second engaging portion as the ascent/descent retaining member moves between the raised position and the lowered position.

5. The disc drive apparatus according to claim 4, wherein the first guide rib is arranged in a region where the first guide rib engages with the first engaging portion when the ascent/descent retaining member is moved to the raised position, and the first engaging portion is opposed to the first guide across a gap as the ascent/descent retaining member moves between the lowered position and a position just short of the raised position.

6. The disc drive apparatus according to claim 3, wherein the sliding member is provided with a third guide rib situated on the side where the sliding member moves in a direction to lower the ascent/descent retaining member and arranged side by side with the first guide on the corresponding sidewall, and
the ascent/descent retaining member includes a third engaging portion arranged on the corresponding arm portion and in contact with the third guide rib.

7. A disc drive apparatus according to claim 1, wherein the disc drive section is provided with a plate-shaped chassis supported on the ascent/descent retaining member and the main frame,
the motor is placed on the chassis, the head portion is supported on the chassis for movement in the radial direction of the optical disc,
the chassis includes a pair of side edge portions extending parallel to the pair of sidewalls, a front edge portion extending along the connecting portion of the ascent/descent retaining member, and a rear edge portion extending parallel to the front edge portion, the pair of side edge portions being bent toward the recording medium, the front and rear edge portions being individually bent away from the recording medium.

8. A disc drive apparatus according to claim 1, wherein the disc drive section is provided with a chassis, including a front end portion supported on the ascent/descent retaining member and a rear end portion supported on the main frame, and a circuit board attached to the main frame on the rear end side of the chassis,
the motor is placed on the chassis,
the head portion is supported on that part of the chassis between the motor and the rear end portion of the chassis for movement in the radial direction of the optical disc,
the ascent/descent retaining member includes a notch formed in the connecting portion and a position regulating portion adjoining the notch,
the motor is electrically connected to the circuit board by a flexible cable,
the flexible cable having one end connected to the motor and the other end connected to the circuit board and overlapping the head portion on a projection plane along an axis of rotation of the optical disc,
one end portion of the flexible cable being located on the ascent/descent retaining member and prevented from moving away from the recording medium by the ascent/descent retaining member, a portion which is continuous with the one end portion being led around to the opposite surface side of the ascent/descent retaining member through the notch thereof to face the position regulating portion, then extending to the circuit board, and being prevented from moving toward the recording medium by the position regulating portion.
